(19) United States
(12) Patent Application Publication
(10) Pub. No.: US 2003/0055983 A1
(43) Pub. Date: Mar. 20, 2003

(54) Methods for providing a virtual journal

(76) Inventor: Jeff Callegari, Kirkland, WA (US)

Correspondence Address: Mark W. Roberts, Esq., DORSEY & WHITNEY LLP, Suite 3400, 1420 Fifth Avenue, Seattle, WA, 98101, US

(21) Appl. No.: 10/102,604

(22) Filed: Mar. 19, 2002

Related U.S. Application Data
(60) Provisional application No. 60/277,174, filed on Mar. 19, 2001.
(60) Provisional application No. 60/277,200, filed on Mar. 19, 2001.
(60) Provisional application No. 60/277,187, filed on Mar. 19, 2001.

(51) Int. Cl. G06F 15/16

(52) U.S. Cl. 709/227; 709/205

(57) ABSTRACT

Methods for providing virtual content are discussed. One aspect of the present invention includes a method for providing a journal. The method includes creating a journal entry that is virtually affixed to a location of interest. The method also includes presenting the journal entry to a selected person when the selected person is within the vicinity of the location of interest.

### CROSS-REFERENCE TO RELATED APPLICATIONS

This application is a sibling of co-pending application Ser. Nos. ______ and ______, and claims priority to provisional patent application Nos. 60/277,174, 60/277,200 and 60/277,187, all filed Mar. 19, 2001, all of which are incorporated herein by reference in their entirety.

### TECHNICAL FIELD

The technical field relates generally to providing geo spatial location specific information in virtual form. More particularly, it pertains to creating and accessing virtual content that is associated with a geographic location as a journal entry. The content is created by and accessed by, users that communicate with a presence server through a consumer device.

### COPYRIGHT NOTICE—PERMISSION

A portion of the disclosure of this patent document contains materials, which are subject to copyright protection. The copyright owner has no objection to the facsimile reproduction by anyone of the patent document or the patent disclosure as it appears in the Patent and Trademark Office patent files or records, but otherwise reserves all copyrights rights whatsoever. The following notice applies to the software and data as described below and in the drawings attached hereto: Copyright© 2001, Cellular Technical Services Company, Inc., All Rights Reserved.

### BACKGROUND OF THE INVENTION

The world is comprised on an enormous number of geographical locations that are visited by various persons and a large number of persons that would like to record information about places visited, or receive such information recorded by others. Such recorded information content may be considered personal journal entries made by persons regarding specific locations. Unfortunately, there are few services that provide access to individual journal entries regarding locations without a great deal of effort on the part of users. The World Wide Web has become an important resource that provides web sites, web pages and variety of information contents stored on a server that can be accessed by users with a personal computer. Typically, the user accesses a conventional search engine to search the World Wide Web for certain words or concepts related to locations in which they have an interest.

One of the problems with using search engines with the World Wide Web is that they are not location specific in a true sense. Users are not able to obtain information content about specific locations without sorting through an unmanageable amount of material that is “hit” as a result of a search. In essence, the user must go through a laborious process to cull information randomly obtained from databases based on the consumer's skill in locating a search engine, the type of search engine, the type of search and the user's skill in constructing the same and skimming through the results.

Mobile communication technology now permits users to access the World Wide Web using portable devices such as cell phones, portable computers, portable digital assistants, “BLACKBERRIES” and the like. These devices use a varied assortment of protocols and/or formats for receiving and transmitting information including, for example, Wireless Application Protocol, HTML and E-mail. These technologies allow users to access information from a mobile platform without being restricted by physical location. Mobile connection to the World Wide Web has all the same limitations as the World Wide Web with regard to user searching for specific geographic location content. Another problem with mobile communication technology stems from the variety of protocols and formats in use, which prevents users from obtaining information content unless the information content is available in a compatible protocol or format for the communication device.

Another type of information service combines mobile communications with various position determining equipment (PDE) to send or receive positional information regarding the user's location. Enterprises that provide positioning equipment and/or locating services are variously called Location Service Providers (LSP), Mobile Positioning Centers (MPC) or Global Positioning Satellite (GPS) services. Example technologies for locating a user's position include GPS systems, assisted GPS systems (A-GPS), time domain of arrival systems (TDA) or signal triangulation systems. While such systems may be useful for mobile communications, they at best have the same limitations as the World Wide Web in terms of locating information content regarding specific locations.

There is, therefore, a need in the art for methods and systems that put users in contact with other user's information on the basis of geographical location, so that users may easily record and obtain information from other users concerning various geographical locations that may be of common interest without combing through a vast amount of random search results.

### SUMMARY OF THE INVENTION

The present invention fulfills these and other needs that will be apparent from the following description of various aspects of the invention. There are provided systems an methods that allow users to provide geospatially encoded virtual journal content in an electronic medium and to interactively create, link, or otherwise deploy that content between users. The content is location sensitive. Discrete messages, newsgroups, bulletin boards, chat rooms, or live instant messaging are all made location sensitive. The term “content” encompasses all of these forms of communication and also includes programming applications and/or applets deployed or executed as part of the content.

This content may be designated private (only accessible to the user/author) or may be shared with others in “buddy lists” for collaboration. The content may also be designated public, which is available to an entire base of users of the system. The virtual content can be in any media or format. For example, the content can include text, voice, video, graphics audio files and the like. Presentation of this content depends on what was created and on individual personalized settings of users who create and/or access the content.

The virtual journal service disclosed herein allows users to establish a private, public, semi-public or other collaborative Context that defines a location-based messaging community. The journal service overlays the physical world of locations. Users can interact with the service in an ad hoc fashion or in a regulated fashion. The content of virtual journals may also be “push” enabled. The term “push” means the inclusion of a technology that receives an indication of user's point of origin (or area of interest) and actively presents information to the user automatically, continuously or at specified intervals, without the need for the user to perform active search queries. Thus, while in certain embodiments the content may be queried by a search using various query interfaces, the content may also be configured to be pushed to users of the virtual journal service.

All of the embodiments of the present invention provide quick, easy and direct interaction between users using a location aware presence server that allows users to share journal entries based on the geographic location of points of interest that are defined by the users.

### BRIEF DESCRIPTION OF THE DRAWINGS

FIG. 1 illustrates features of users and locations according to one aspect of the present invention.

FIG. 2 illustrates other features of users and locations according to one aspect of the present invention.

FIG. 3 is a pictorial diagram of a graphical user interface (GUI) for creating buddy lists according to one aspect of the invention.

FIG. 4 is a pictorial diagram of a GUI for selecting a service according to one aspect of the invention.

FIG. 5 is a pictorial diagram of a user locating GUI according to one aspect of the present invention.

FIG. 6A is a block diagram of a basic system according to one aspect of the present invention.

FIG. 6B is a block diagram of an expanded system according to one aspect of the present invention.

FIG. 7 is a schematic diagram of an Application that implements methods according to one aspect of the present invention.

FIG. 8 is a pictorial diagram of a GUI for configuring a device interface for communication with a consumer device according to one aspect of the invention.

FIG. 9 is a GUI for selecting a private service context according to one aspect of the invention.

### DETAILED DESCRIPTION OF THE INVENTION

In the following detailed description of exemplary embodiments of the invention, reference is made to the accompanying drawings, which form a part hereof, and in which are shown, by way of illustration, specific exemplary embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical, and other changes may be made without departing from the spirit or scope of the present invention. The following detailed description is, therefore, not to be taken in a limiting sense, and the scope of the present invention is defined only by the appended claims.

As used herein, the term “journal entry” is information content that is stored on electronic medium that includes a definition of a geographic location and a message or other note associated with that geographic location. Typically, a journal entry is entered using a consumer communication device that may be wired or wireless. The term “wired”, with respect to a communication device includes any hard line data communication conduit, including, for example, cable, telephone lines, fiber optic lines and the like. The term “wireless” includes any device that communicates data without need of a hard line.

A “user” refers to any person, business enterprise or other entity that communicates with, and/or subscribes to, a service that implements the methods and/or systems described herein.

An illustrative aspect of the invention includes a method for providing a virtual journal that includes receiving a journal entry in an electronic medium from a first user. The journal entry includes a definition of a geographic point of origin and information content associated with the geographic point of origin. The method further includes receiving an indication from a consumer device that includes a location defined by a second user and presenting the journal entry in electronic medium to the consumer device if the location indicated from the second user overlaps with the geographic point of origin defined by the first user.

In certain embodiments, the first user is the same as the second user. In other embodiments the first and the second users are different. Typical embodiments also include receiving an identification of the second users from the first user, so that presenting the journal entry occurs only if the second user is a user identified by the first user. In some embodiments, the identification of the second user includes a buddy list of a plurality of second users. Other embodiments include defining a Context criteria of access for the second user so that presenting the journal entry only occurs if the second user fulfills the Context criteria.

In some embodiments, the definition of the geographic point of origin is selected from at least one of, a place name, a geographic address and geo positioning coordinates. The geographic point of origin may includes a defined area of interest around the point of origin. The area of interest may be defined by the first user, assigned by a service provider, selected by the first user from a list, defined as a geographical boundary, or defined by a geometric form encompassing a defined distance from a point origin for the geographic location received from the first user. In similar embodiments, the indication of the location received from the consumer device includes an area of interest for the second user and the journal entry is presented to the consumer device only if the second user's area of interest overlaps with the definition of geographic point of origin defined by the first user. In some embodiments, the area of interest for the second user is defined by the second user, assigned by a service provider, selected by the second user from a list, defined as a geographical boundary, or defined by a geometric form encompassing a defined distance from a point origin of the second user.

In various embodiments, the information content associated with the geographic point of origin may include an indication of a first category of interest so that the journal entry is presented to the consumer device only if the second user indicates a second category of interest that overlaps with the first category of interest. In some embodiments, at least one of the first category of interest and the second category of interest is determined from a list of keywords contained within the information content associated with the location.

In some embodiments, receiving the indication of location from the second user includes receiving geographic positioning coordinates from the consumer device. In certain embodiments, the geographic positioning coordinates are automatically changed as the location of the consumer device changes and the presentation of the journal entry changes in response to the changed location of the consumer device

In some embodiments, presenting the journal entry includes selecting a protocol and/or a format that is compatible with the consumer device so that the journal entry is transmitted using a compatible protocol and/or format. The compatible protocol and/or formats may include any type electronic format, including but not limited to HTML, XHTML, Web format, Wireless Application Protocol, Wireless Markup Language (WML), Voice extensible Markup Language (VoiceXML), Short Message Service (SMS), and E-mail. In some embodiments, the journal entry may include a Web page and the act of presenting presents the Web page to the second user if the consumer device has the capability to view the Web page. In other embodiments, the journal entry is presented as an E-mail message to the second user if the consumer device has the capability to receive E-mail. In still other embodiments, the journal entry may include an audio file and the act of presenting presents an audio message to the consumer device if the consumer device has the capability to receive an audio message. The act of presenting to the consumer device may be selectively enabled or disabled by the second user.

Systems and applications for implementing the various embodiments of the invention are also described. One embodiment of a system includes a presence server that stores a journal entry concerning the geographic location of interest The journal entry includes a defined point of origin for the geographic location of interest and information content concerning the geographic location received from a first user. The system also includes a communication port operably configured with the presence server to receive an indication of a second user's location from a consumer device and to present the journal entry to the consumer device if the indication of the second user's location overlaps with the defined geographic location of interest. The system also includes a device interface operably configured with the presence server to format the journal entry to be compatible with the consumer device in at least one of a protocol and format recognized by the consumer device. Some embodiments of the system are configured to communicate with a location service provider to receive the indication of the second user's location and to receive an indication of the protocol and format recognized by the consumer device from the location service provider. Other embodiments of the system are configured to receive information pertaining to the compatible protocol and/or formats directly from the users.

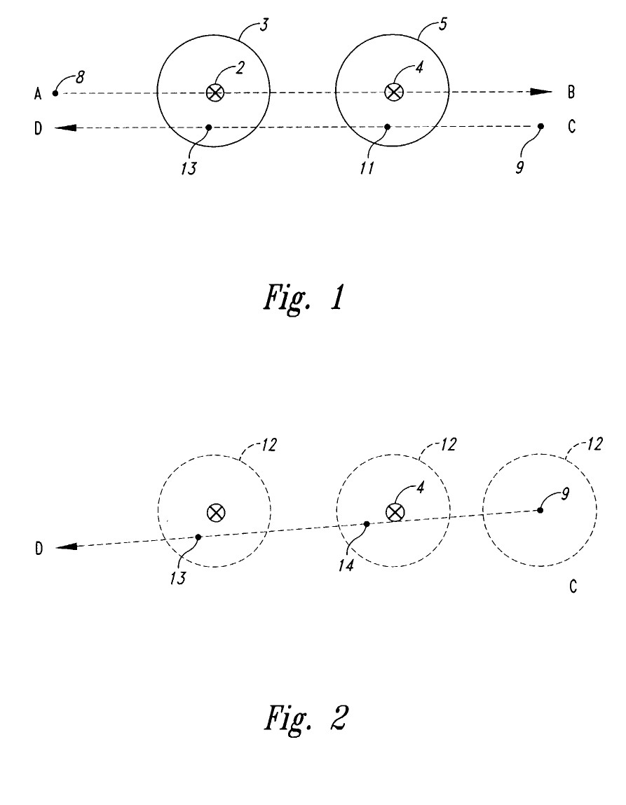

FIGS. 1 and 2 illustrate features of users and geographic locations pertinent to various embodiments of this invention. As shown in FIG. 1, a first user 8 is located at position A travels to position B. Along the way, the first user encounters various geographic locations of interest defined in part by points of origin 2 and 4 for each geographic location. The geographic locations may be merely a geographic position or may be an enterprise or attraction located at the points of origin 2 and 4. The points of origin 2 and 4 may be defined by the first user 8 in various ways, for example, by an address, geo positioning coordinates, or a place name. It is understood that any address or place name has corresponding geo positioning coordinates associated with it and that certain geo positioning coordinates can be mapped to a known address or place name.

Each location also has an area of interest 3 and 5 surrounding its points of origin 2 or 4. The areas of interest 3 and 5 may also be defined by the first user 8 or be defined automatically be defined by default by a system that implements the methods disclosed herein. The areas interest 3 and 5 may, for example, be defined as a geometric area encompassed by an ellipse or rectangle with a perimeter located a specified distance from the point of origin 2 or 4. Alternatively, the area of interest 3 or 5 may be defined by socio-political boundaries, such as the boundaries of a neighborhood, city or other circumscribed region The areas of interest 3 and 5 may, therefore, be any size, for example, as small as the width of a shop window or as large as a state.

When the first user 8 encounters a geographic location of interest, the user 8 accesses a system provided herein and makes a journal entry that includes information content associated with the geographic location and a definition that includes the geographic point of origin 2 and 4 of the location of interest. The journal entry is made using a consumer device that transmits the information in an electronic medium to a system described herein. The consumer device may be any communication device equipped with electronics that allow the user to interact with a database including a wired or a wireless device. Suitable consumer devices include, but are not limited to, mobile telephones, mobile computers, personal desk top computers connected to the World Wide Web, personal digital assistants, and the like. The journal entry may be in any suitable format for the consumer device, including but not limited to voice, audio, video or text format. When the journal entry is made, it is stored in electronic medium as an association with the geographic location of interest by the point of origin 2 or 4, the area of interest 3 or 5 or both point of origin and area of interest.

Continuing with FIG. 1, a second user 9 makes an independent journey from point C to point D. The second user 9 transmits an indication of various locations shown by points of origin 11 or 13 for the second user. These indications of location may be points traversed during a trip or may be independently indicated by simply entering a desired point of origin. Alternatively, the second user 9 transmits an indication of location for points of origin 2 or 4 in the same manner as the first user, i.e., by place name, coordinate position or address. Upon receipt of the indication of location, the system provided herein determines whether the indication of location transmitted by the consumer device from the second user overlaps with the area of interest 3 or 5 or the point of origin 2 and 4 defined in the journal entry of the first user 8 If so, the journal entry of the first user 8 is presented to the consumer device of the second user 9. The second user 9 may also make a journal entry regarding the same geographic location of interest and that entry will also be presented along with entry by the first user to any user who transmits an indication of location that overlaps with the geographic location of interest.

FIG. 2 illustrates embodiments where the indication of location provided by the second user 9 includes an area of interest 12 defined for the second user. The area of interest 12 changes with the point of origins 11 and 13 for the second user. The second user 9 may define the area of interest 12, the area of interest 12 may be defined by default by an automated system, be selected by the second user from a list of options, may be defined by a geo political boundary, or as a geometric area encompassing a defined distance from the second user's points of origin 11 or 13, as with the first user. In these embodiments, journal entries are presented to the second user 9 only if the area of interest 12 defined by the second user overlaps with the point of origins 2 and 4 of the geographic area of interest, or overlaps with the areas of interest 3 and 5 associated with those geographic points of origin 2 and 4, respectively.

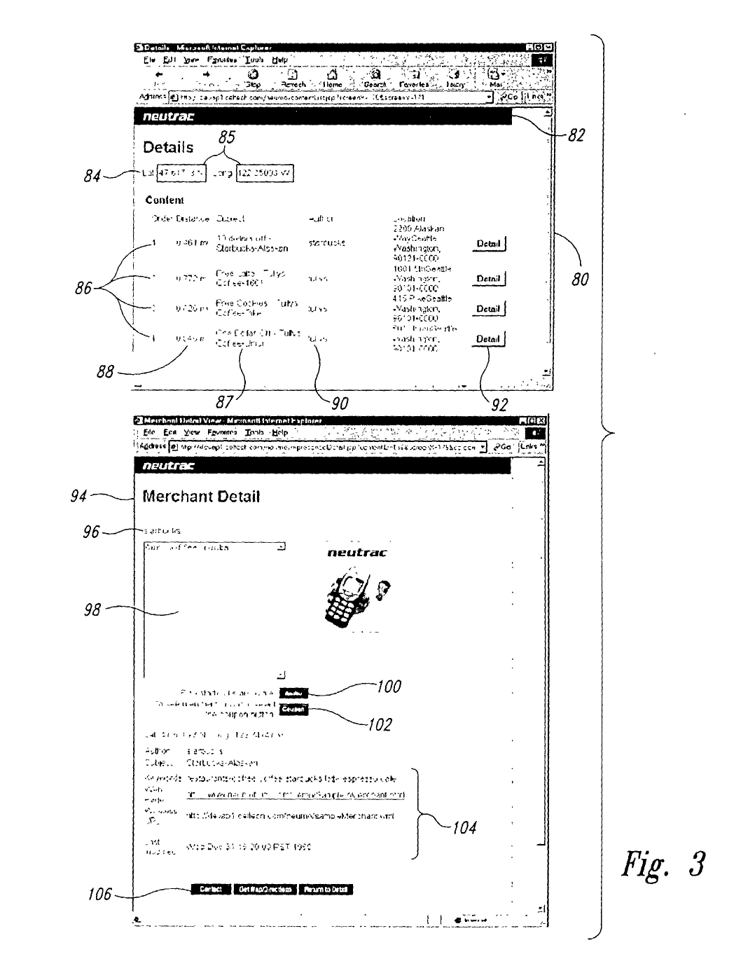

FIG. 3 illustrates a Buddy List GUI 39 for accessing and/or establishing a list of users that share access to journal entries made by the first user 8. The Buddy List GUI 39 includes a banner 82 indicating the service provider, an identified user name 31 that identifies the current user and a select type list 32. The select type list 32 provides the identified user 31 with the opportunity to select among various options such as displaying the buddy list. The Buddy List GUI 39 includes a buddy list field 33 that list names for a variety of buddy lists that may be established by the identified user 31. For example, one buddy list may include business associates, another may include friends and another may include family. Each of these different types of buddy lists may have different levels of Context for different levels of access, i.e., some maybe private, other semi-private, and still other public. Context is described in more detail elsewhere in the present disclosure. These Context attributes are determined by the identified user 31 when establishing a new list. All available buddy list for the identified user 31 are listed in the buddy list field 33 while each user name within the selected buddy list 33 is displayed in a buddy names field 34. A note field 35 is provided for the identified user 31 to create a summary description of each buddy list displayed in the buddy list field 33. The identified user 31 may edit an existing buddy list 33, create an entirely new buddy list or remove an existing buddy list using an Edit button 37, New List button 38 or Delete List button 39, respectively. In addition, a Pool List button 40 permits the user to manage buddy lists by merging two or more buddy lists 33 into one.

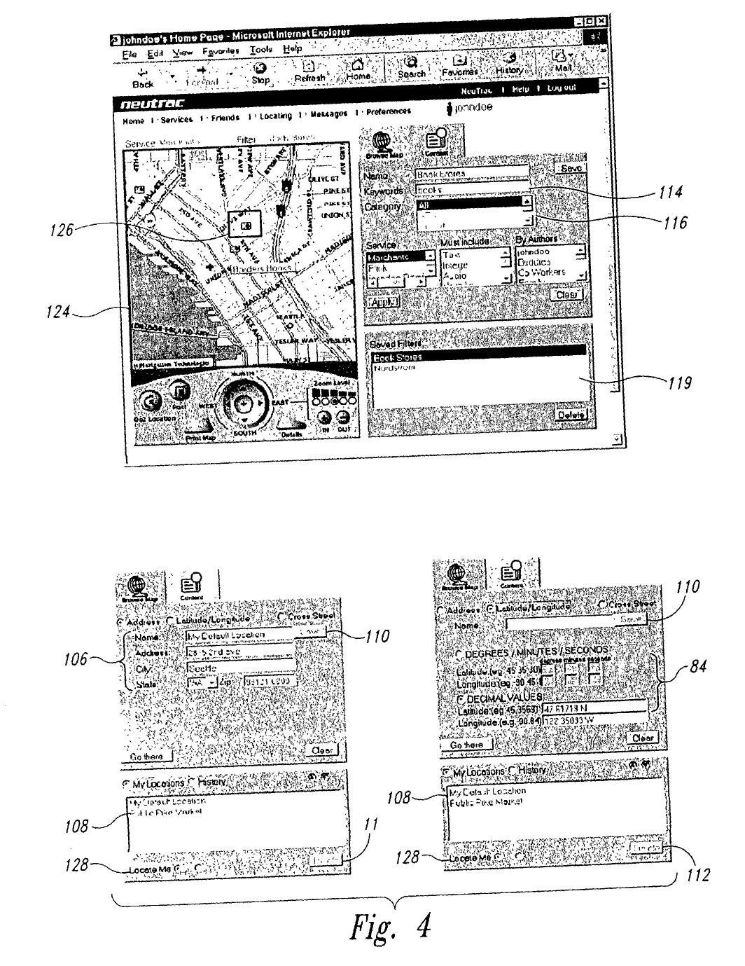

FIG. 4 illustrates a Select Service GUI 29 for choosing among a variety of types of location specific journal content that is useful for obtaining virtual information for users operating business services. The Select Service GUI 29 includes the banner indicating the operator 82 of the service and an option list 21 for selecting from a plurality of types of virtual information content services. The types of business services available include services for creating a virtual private service 21, a virtual coupon 22, a merchant presence 23 and a buddy list 24. The virtual coupon 22 and the merchant presence 23 are described in greater detail in co-pending sibling applications No. ______ and ______ . The Select Service GUI 29 also includes an interest category list 25. The interest category list 25 serves as a category content filter that allows the users of the system to filter the types of information that will be presented according to categories. The items in the interest category list 25 may be user defined or pre-selected by the service provider 82. Example interest categories in category list 25 include business (i.e., the options displayed in select service interface 20), city/region, people, entertainment, lifestyle, news, sports, travel, weather, games, system, and journal 28. The journal 28 category links to the Select Service GUI 29 for creating virtual journals.

The consumer device may be operated in a conventional search mode. In the search mode, the user defines searches for specified locations with category filters. A large number of variables affect whether a user desires to receive information content regarding geographic locations of interest. There may, for example, be a very large number of such geographic locations in the user's defined area of interest 12 about which the user has no interest. Accordingly, in various embodiments, users search within, or otherwise define categories of interest and journal entries are only transmitted that overlap with the category of interest. The category of interest may be pre-assigned to a journal entry by a service provider, selected from a list of categories provided to the user or defined by the user, for example, using keywords.

One embodiment of a selectable category is a “channel”. A channel operates as a filter that restricts transmission of data to information that meets predetermined categorical criteria. Channels may include one category of information or may include a combination of categories. For example, one category may be “movies,” another category may be “restaurants,” another category may be “mechanical services” and yet another category may be “gas stations”. The first two categories may be grouped on a channel entitled “night life” while the latter two may grouped on a channel entitled “automotive” The user may select a channel to receive journal entries only in the selected channels. A similar example of a category is a “favorites list.” The user defines a list of particular categories in which he or she is most often interested. The defined categories are saved on the favorites list so that the user can quickly receive journal entries pertaining to the categories stored on the favorites list.

In other embodiments, presentation of journal entries need not require an actives search by the user. Rather, the journal entries may be actively “pushed” to the users based on the indicated location received from the consumer device without the need for the user to actively search. To illustrate by example, as a users strolls down a city block the precise coordinates of the user's point of origin changes. If the consumer device is configured with an area of interest defined at 500 feet, is set in the scan mode or the sensing mode, then the journal entries available at one end of the block will be different from the journal entries available at the opposite end of the block. When information is pushed, a user may desire to selective disable or enable the pushing in order to limit unwanted information.

In these embodiments, the indication of the user's point of origin 11 or 13, location area of interest 3 or 5 and/or user's area of interest 12 is received in at least one of three non exclusive modes: a site mode, a sensing mode and a scan mode. In the site mode, the consumer transmits a single indication of a particular location, typically defined by an exact point of origin such as an address, and receives only information regarding information content associated with that particular location. For example, if the consumer device transmits “101 Main Street, Small Town”, only journal entries about sites located at that building address in Small Town are transmitted to the consumer device. The request mode is, therefore, limited to information for a single location.

In the sensing mode, the consumer device continuously or (periodically) transmits changing indications of the user's point of origin as the user moves from location to location. The sensing mode typically requires that the consumer device be equipped with position detection equipment, such as a GPS or other system that allows the user's location to be tracked. In the sensing mode, the user obtains continuously changing information regarding locations, which corresponds to the geographic locations in proximity to the consumer's continuously changing positions.

In the scan mode, the user sends an indication of a point of origin and receives information concerning a plurality locations in proximity to that point of origin. The scan mode may be considered similar to the site mode, but with a larger defined area of interest 12. In certain embodiments, the scan mode is a default mode that operates with an initially defined area of interest 12. In other embodiments, the user may set a larger area of interest in order to obtain a greater amount of information or a smaller area of interest 12 to obtain less information.

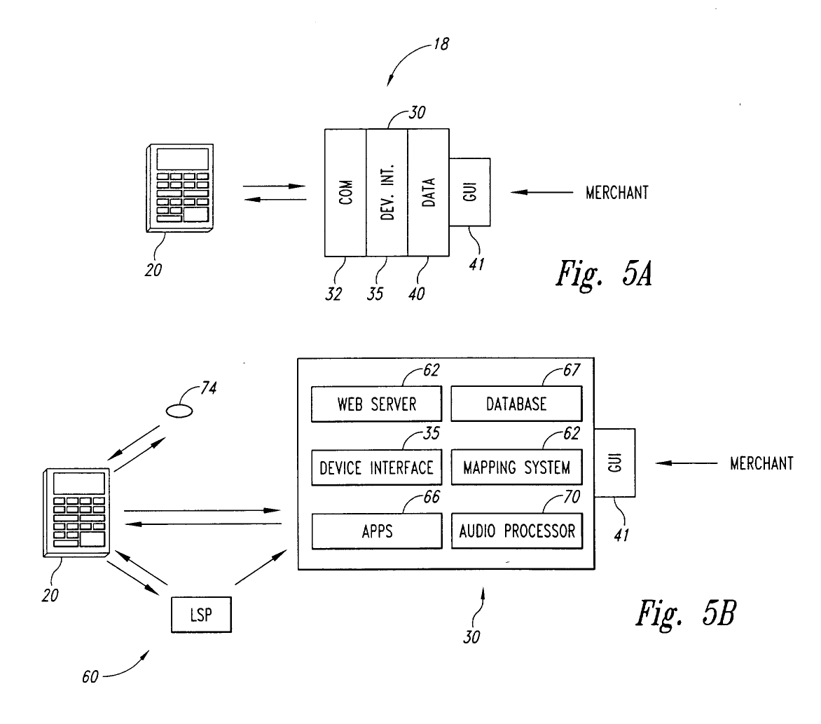

FIG. 5 illustrates a Locating GUI 40 that allows a user to enable, disable, or selectively enable virtual content that is pushed to the user when the user sends and indication of his or her location. The Locating GUI includes the banner indicating the service provider, the name of the identified user 31 and the selected service field 32. The Locating GUI 40 provides a default service radius select field 41 that allows the identified user 31 to select or define a radius to define the user's 32 area of interest 12 from his or her point of origin 11 for receiving information in a search mode. A default push distance field 42 allows the user to select or define the radius of the area of interest 12 from his or her indicated point of origin 11 in which the identified user 31 will permit information to be continuously pushed to the identified user's 31 consumer device, for example, when operating in the site mode, scan mode or sense mode. A Time duration field 43 is also provided to allow the identified user 31 to control the time period for which information will be pushed to the identified user's 31 consumer device. A master kill or enable option button 45 is provided to disable or enable all information pushing. A selective enable list 46 is also provided, to allow the identified user 31 to select other users, buddy lists, businesses, or other categories of users that will be allowed to locate the identified user 31 so that the identified user 31 only receives the push of information content from the enabled list 46 of users.

In various embodiments, the use of categories is combined with the aforementioned modes of sending the indication of the user's location and of selecting the size of the area of interest 12. For example, the site mode mentioned above is typically used in the absence of a category filter because a single location is likely to have a limited number of journal entries associated therewith. The sense mode is typically used with a broad category filter or no filter, but with a relatively small area of interest so that the user may receive all available information from location to location.

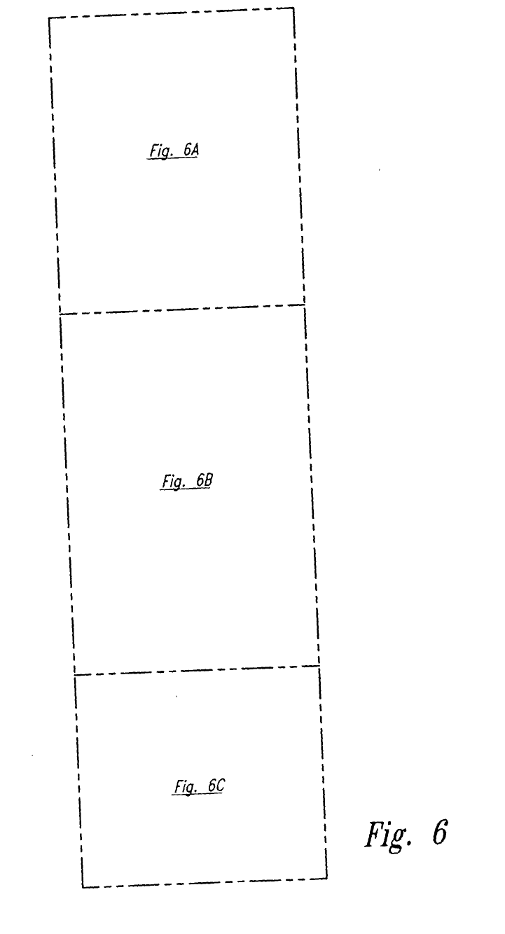

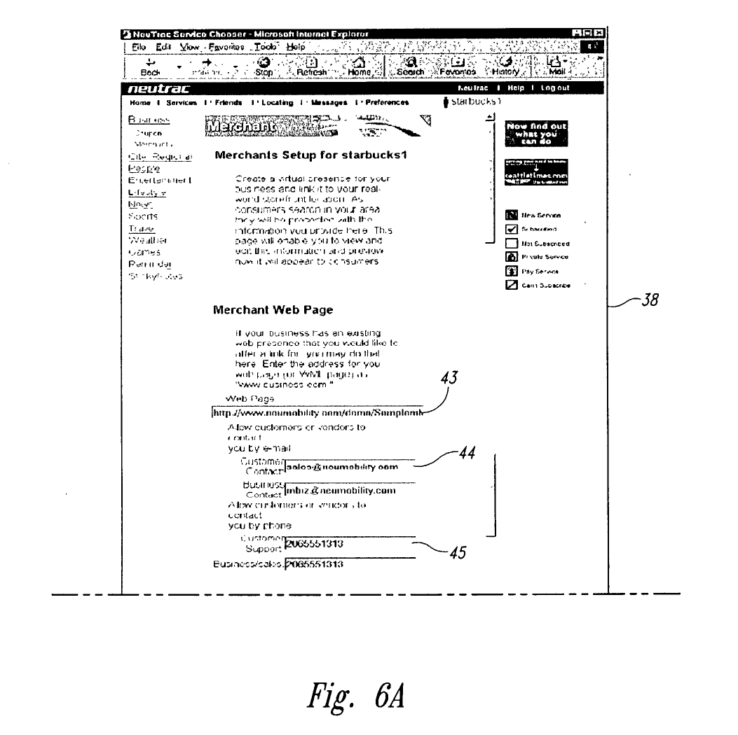

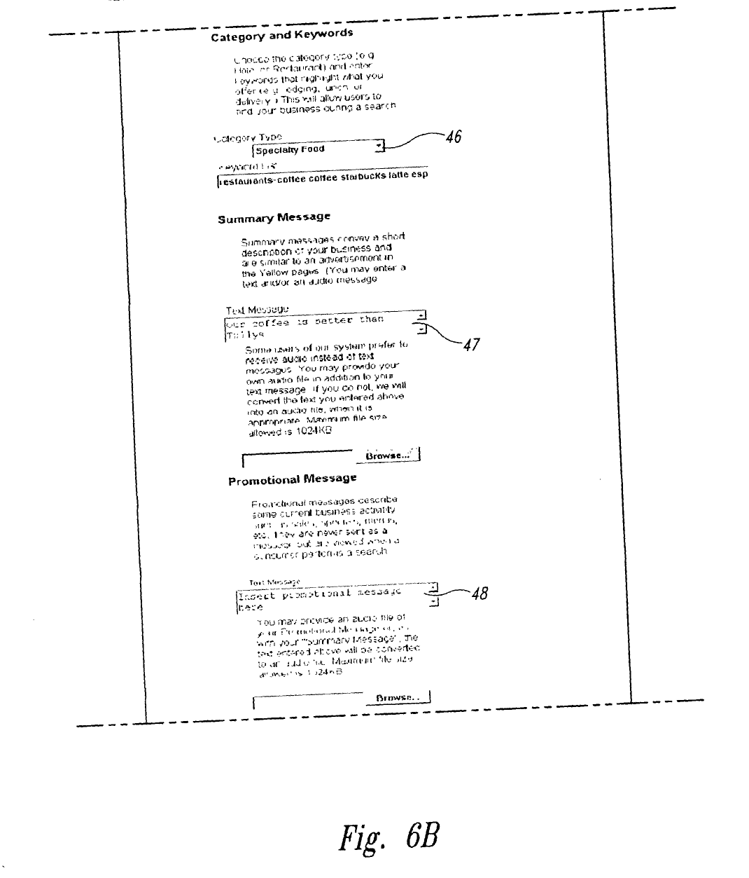

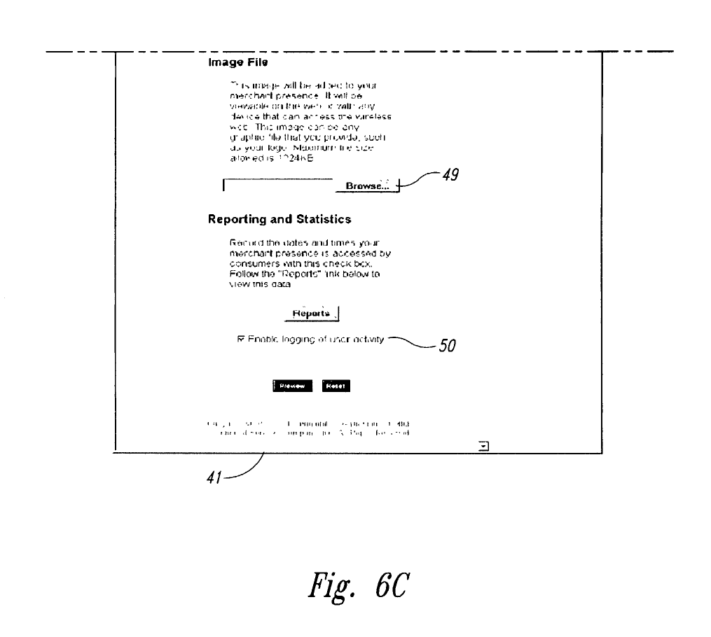

Another aspect of the present invention is a system for providing the journal entry to a user whenever the service provider receives an indication from a consumer device that the second user 9 is near a geographic area of interest previously defined by the first user 8. FIG. 6A is a block diagram of a basic system 18 according to this aspect. The basic system 18 includes various pieces of software and hardware that provide the journal entry to the second user 9 based on receiving an indication of the second user's 9 location. The users interact with journal entries through the consumer device 20.

The basic system 18 includes a presence server 30 that receives journal entries ,for all users, receives an indication of location from the second user 9 and presents the journal entry to the second user 9. The presence server 30 includes a device interface 35 that structures the journal entry into a format and/or a protocol recognized by the consumer device 20. The presence server 30 also includes a communication port 32 for transmitting the journal entry to the consumer device 20 in the appropriate format or protocol. The communication port 32 may be configured with a wireless or wired communication line.

The presence server 30 selects the appropriate protocol or format for the device interface 35 by receiving an indication of the type of consumer device 20. The indication of the type of consumer device 20 may be set-up by the user, may be received de novo along with the indication of the second user's location, or may be “looked-up” on a subscriber list that identifies the user, the consumer device 20 and appropriate format or protocol. Such a list may be contributed to directly by the user via configuration parameters applied when the user subscribes to a service for contacting the presence server 30 as illustrated in FIG. 4. Alternatively, the list may be obtained from another service provider, for example, a mobile communication service or LSP that equips the user with the consumer device 20.

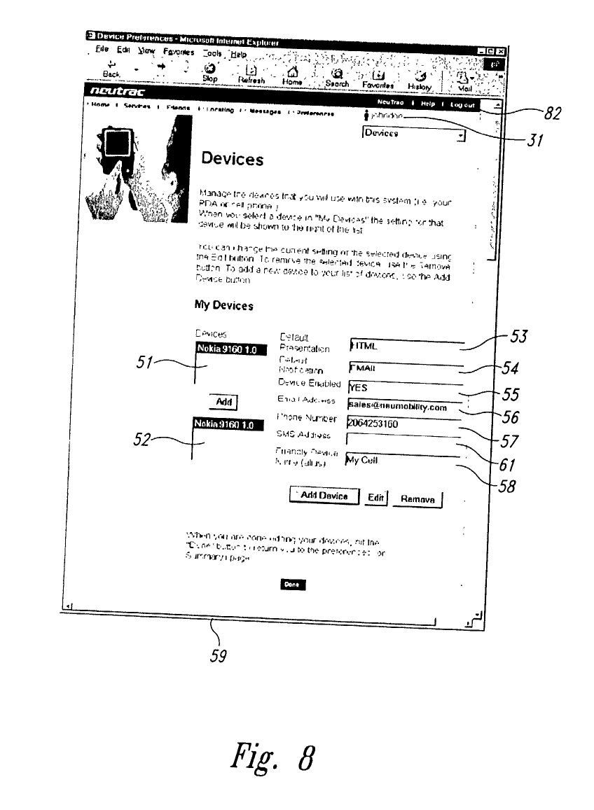

FIG. 8 illustrates a Device Preferences GUI 59 that allows the identified user 31 to configure their own consumer device 20 for receiving presentations of information content in a protocol and or format that is compatible with their particular consumer device 20. The Device Preferences GUI 59 includes a list of selected consumer devices 51 that the identified user 31 may use from time to time. These are typically selected from a master selection list 52 that preferably includes a name of all known types of consumer devices 20 with predefined formats and/or protocols. The identified user 31 is able to set a default format for presentation of different types of information. For example, a default presentation field 53 determines the format the consumer prefers to receive presentation information while a default message field 54 determines the preferred format for receiving short messages. The Device Preferences GUI 59 also includes an enable button 55 to selectively enable communication with the selected device 51. An E-mail field 56 is provided for the identified user 31 to enter a preferred E-mail address, a telephone field 57 is provided for entry of a telephone number for the device, a device nickname field 58 is provided to allow the identified user 31 to apply different names to similar devices, and an SMS field 59 is provided for entry of a path for SMS voice messages.

As mentioned, the device interface 35 selectively communicates to the consumer device 20 through the communication port 32 using the appropriate format and/or protocol for the type of consumer device 20. For example, if the consumer device 20 can interpret hypertext markup language (HTML), the device interface 35 may send information in the form of HTML pages to the consumer device 20. User I/O compatibility is diverse and includes standard Web access, voice input through an IVR system, SMS messaging, E-mail, and other types of messaging technology. Accordingly, the device interface 35 is configured to communicate to the consumer using a variety of techniques including, but not limited to Wireless Application Protocol, Wireless Metal Language (WML), Voice eXtensible Markup Language pages (VoiceXML), Short Message Service (SMS) or E-mail. Depending on consumer device 20 capability and configuration, the presence server 30 may be acting as transmitter to the consumer, receiver from the consumer, or both.

The presence server 30 also includes a storage medium 40 and a merchant interface 41 that enable the merchant to enter and store information concerning the merchant's presence, such as geographic point of origin, service area, name, category of goods and services, business mark, description of the business and the like. The storage medium may also store subscriber information regarding individual consumers. In various optional embodiments, the merchant interface also enables the merchant to define a Web site, define a Web page, define an E-mail, define keywords, define an audio file, define a video file, and/or define forms for interacting with the consumer. The storage medium 40 typically stores a database 69 of merchant and/or consumer information.

FIG. 6B illustrates an expanded system 60 that includes various components for certain embodiments of the presence server 30. This embodiment of the system 60 includes a Web server 62 that serves HTML pages. The merchant interface 41 of the presence server 30 may be implemented to transmit Web pages to the consumer device 20 thorough the device interface 35 if the consumer device 20 can interpret HTML pages. The expanded system 60 include a VoiceXML server 64 that provides Voice extensible Markup Language pages when the consumer device 20 is configured to receive and interpret VoiceXML pages. The expanded system 60 may also include a number of merchant applications 66. The merchant applications 66 include programs that enable the merchant to tailor the merchant presence to merchant defined specifications, including the information necessary to define the merchant presence as well as programs for conducting business with the consumer The merchant applications 66 may include, for example, demographic statistics and other tracking features that enable the merchant to keep records of contact with consumers. The merchant applications 66 may also include various applications implemented by the merchant for doing business, for example for taking orders, making reservations, accepting forms of payment and the like.

The presence server 30 of the expanded system 60 is configured with a number of other sub-systems and/or applications that enhance the merchant presence. These other systems include, for example, the mapping system 68. The mapping system 68 provides the merchant point of origin, address and routing instructions to the consumer based on the received indication of the consumer's location. It may also be used by the consumer to map the location of a plurality of merchants within the consumer's area of interest as shown in FIG. 4. The presence server 30 also includes an audio processing application 70 that allows processing of audio information for voice recognition, voice to text, or text to voice conversions. When configured with the device interface 35, the audio processing application 70 allows transmission of messages a broad variety of consumer devices 20, which may be as basic as a plain old telephone system (POTS) or as sophisticated cellular phone with digital personal assistant technology.

The expanded system 60 typically includes various databases 69 to keep information regarding the plurality of merchants consumers. In one embodiment, the database 69 is implemented using Oracle, but any suitable database technology can be used, such as Microsoft SQL server. The database 69 and respective application software may be used to create systems for storing the “location” and “content” merchant information. In addition these databases 69 may provide subscriber subsystems, billing subsystems, or administration subsystems to assist in commercial deployment of the system 60 to serve a variety of users and markets.

The consumer device 20 depicted in the expanded system 60 may be configured with a positioning application or position determining equipment (PDE) 72 that enables precise determination of the point of origin of the consumer device 20 using positioning coordinates determined by a location service provider (LSP) 71, a mobile positioning center (MPC) or by direct communication with a global positioning satellite 74. The presence server 30 is configured to receive information as to whether a particular consumer device 20 includes the PDE 72, and if so, what type. The presence server 30 may then utilize the positioning coordinates provided from the PDE 72 directly from the consumer device 20 to automatically detect the consumer's point of origin as it changes. Alternatively, the presence server 30 may receive positioning coordinates from the consumer device 20 indirectly from the LSP 71or MPC. Another type of positioning is “manual” positioning where the user sets their position through normal data entry including latitude and longitude, address, cross street, zip, or by selecting location “bookmarks” or through selection of location history.

In one embodiment, the presence server 30 only receives the positioning coordinates if the user first obtains the signal independently and then authorizes its transmission to the presence server 30. In other embodiments, such as in the sensing mode, the consumer's location is tracked and the positioning coordinates are transmitted to the presence server 30 automatically. In these embodiments, the consumers position is tracked as the consumer moves. In still other embodiments, the consumer may store the most recent indication of the consumer's coordinates or the consumer's home position, and receive merchant information for that position whenever the presence server 30 receives an indication of that position.

The embodiments of the present invention enable merchants to easily create, deploy, and sustain a location specific wireless and non-wireless presence. The merchants can do so with or without assistance from a third party agent other than the provider of the presence server 30 and that implements the methods disclosed herein. However, other third party providers such as ISPs LSPs and MPCs and the like may also utilize the system on behalf of their clients.

The system 60 does not require significant design talent on the part of its users, other than operating a browser and filling out forms (e.g., formal web experience). Therefore, the system 60 is available for use by a broad base of merchants and consumers. Some of these merchants may have expertise in web presence and others may not. The merchant presence captures the merchant information within a system application database 69, which also supports links to external sources. Merchants that already have a home page (wireless or non-wireless) can link these external sources to this location-based presence, thus, in fact automatically making their existing non-location enabled presence, location sensitive.

In a more general aspect of the invention, the presence server 30 and transmission of the merchant's presence to a consumer device 20 based on location is part of an overall Application that allows a variety of users types to find, detect, track and interact through location-aware technology. The Application has aspects that extend to any location-aware reception and transmission of information.

In this more general aspect, any space in the physical world can be “mapped” to a defined location. For each location, a user of the system may create associations (e.g., a presence) that is stored on electronic medium in the virtual world. Any given location in space may have an untold number of virtual records or “associations” therewith, including for example, attachments, links or other annotations connected to the location. The virtual presence associated with the physical location is accessed using any communication device equipped with location specific functions, for example, a cell phone, appliance, PDA or other computing resource. To facilitate understanding of this broader aspect, it is helpful to further define certain terms to reach a common understanding of the meaning thereof:

A “location “is a reference to a feature in the physical and virtual world that has a number of dimensions:

One physical dimension of location is “origin” or “point of origin” which has been described previously herein to include at least one of an address or coordinates such as latitude and longitude that define a reference point for the center of the location. Any unique address represented in the conventional form by number, street, city, state and country has a corresponding unique representation in global positioning coordinates, and thus all points of origin are unique although they may have numerous forms of representation.

Another physical dimension of location is “size,” which is a generic term for the area of interest (or service area) defined by a user as previously described. Typically, the size of a location may simplistically be defined by an ellipse, rectangle or other geometric boundary that encompasses an area. A radius, length, or other unit of measure of distance can then be used to describe the size of the location based on a reference to its origin and geometric boundary.

One virtual dimension of location is “Context” which is defined by a system operator or user to characterize the attributes of access and/or electronic interactions allowed between users and locations. Information, applications, or behaviors of locations may be different depending on the context that is applied to it. For example, a given location may have information that may be characterized as private, public, public moderated, or commercial. In this example “private” would classify information that is only accessible by a particular user or set of users, “public” would be accessible to all, “public moderated” would be managed by a third party, and “commercial” would be managed by a commercial enterprise. Other example of Context include those used in URL addresses on the World Wide Web, such as “gov” or “edu.”

Another virtual dimension of location is “Category”, which describes topic filters applied to the location under a particular context. A category includes, for example, user defined types and subtypes of information related to the location. One example of implementation of a category is a “channel” as previously discussed. For example, a channel may include specific category sets like Restaurant, Historical, Crime, Geology, Graffiti, Travel, and the like, or may include larger sets like Leisure that include several subsets.

Another virtual dimension is “meta data” or keywords, which act as both a structured and freeform description pertinent to location. One example of this implementation could be specifying a restaurant category AND keywords such as “vegetarian”, “kids” or “fish”.

Another virtual dimension of location is “Time” Any location may have a sense of time that is applied to attachments and other associations as a time stamp. Users access the location in the time domain as well as the physical domain.

Yet another virtual dimension of location is “Behavior,” which relates to how the association or attachment of information is stored or communicated. Behavior may differ based on the user access device, the user, the Context, the Category, the Time, etc. Behavior is typically implemented by program applications. Behavior examples include, but are not limited to, items like “notification,” “display,” “sound bite” and the like.

“Content” is the actual virtual information associated with location and stored on computer readable medium. Content can be anything, for example: text notes, SMS, WebPages, WAP, voice memos, sound, images and the like. Content can be stored by value or by reference. Locations can be absolute or regionalized into “views”. Behaviors can be created for locations and/or particular location views. In one aspect, content creation is provided to users on an ad hoc basis to facilitate ease of use, and self-propagation of content.

The Content of information associated with the location may also have various “Properties”. Example properties include, “type” which includes descriptive forms such as E-mail address, URL, audio file and the like. Another property of Content is “Persistence”, which determines how long the author or creator of the content desires their contribution to persist. Yet another property is “Security,” which is a user definable attribute of access. Although some level of security is provided by the Context, particular users may apply different levels of Security to their information content.

Another property of Content is “Selected Area.” As mentioned above, a location includes a defined area of interest or service area, however, the user may wish to select a smaller or larger area of interest (radius) for particular purposes based on particular conditions. For example, a user may select a large area of interest when accessing or transmitting location information about a city, or select a smaller area when accessing or transmitting location information about a street. Different Content may be transmitted depending on the Selected Area.

“Content Behavior” is a property similar to the behavior dimension of location, but associated with content. For example, when a piece of content is accessed there may be a prescribed behavior associated with the access. This could be as simple as registering how many times the content is accessed, by whom, when, etc., or as complex as executing a series complex scripts or program applications.

In typical embodiments, this system interacts with locations by interfacing with existing LSPs, MPCs or other position tracking services. Suitable commercial LSPs and MPCs are exemplified by companies such as SignalSoft, Cell-loc, and Ericcson. For example, Signal Soft implements a mobile location service with their LocationManager product. Such products provide the locating hardware and software needed to communicate the positioning coordinates and other “where” based finctions required for large system implementation. The LSP or MPC provides interoperability between service regions and disparate equipment and technology providers. The LSP or MPC may also provide application developers with a common API with which to develop location specific applications.

The Application provides a standardized method of interacting with wireless resources to provide consistent usability across the Application “System”. The infrastructure easily supports advanced functionality through the inclusion of location and content external reference calls based on user actions. User actions may include both location and content events. It provides an overall framework that supports by design (out of the box) most of the “informational” types of “applications” that would otherwise require discrete applications to be developed and deployed. The Application grows with contributors and users and does not need massive content initialization. The Application may be used ad hoc but is also amenable to structure and commercialization because it provides “just enough” organization to combine Location, Content, and Time within a common controllable application.

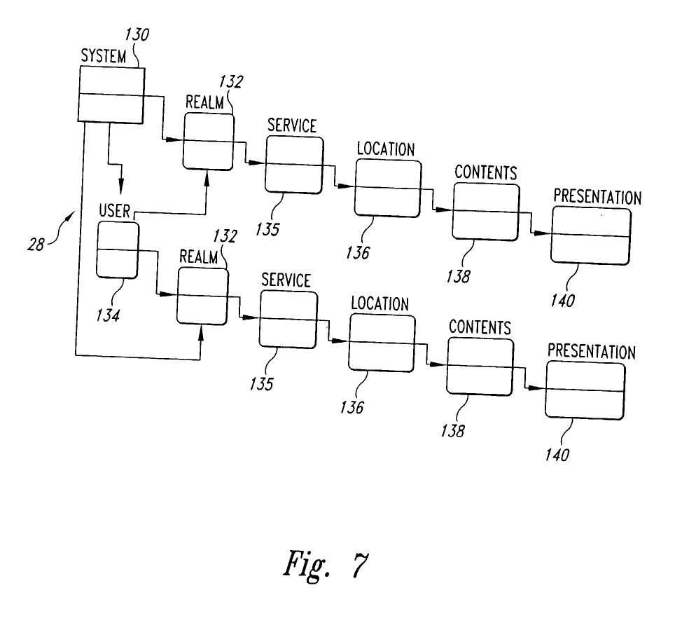

FIG. 7 is a schematic overview of one embodiment for organization of the Application 128 that underpins a network of presence servers 30 described herein. The Application 128 includes a central database/application herein designated the “System” 130 and ‘n’ number of distributed databases/applications herein designated a “Realm” 132. The System 130 is a centralized service that links Realms with Users 134. The System database may be deployed at a single centrally located geographical site or may be distributed through a number of sites by linking a network of servers. The System 130 applies application and business rules to the interaction of Users and Realms.

The Realms 134 are distributed applications and databases. Realms 134 interface with the System 130 to manage User 134 activity and accounting, User rooming events, and other system wide interactions. The Realm 132 includes Service applications 135, that in turn organize and operate on Location specific 136 information for the Users 134, the Content 138 of the location information, and the Presentation objects 140 needed to present the Content 138 to the Users 134. Hence, the primary function of the Realm 132 is to manage the list of Location objects within each Realm. A Realm 132 administrator is constrained to administration of Locations within its respective Realm.

User 134 accounts are created and managed by a system object. User objects on the System 130 capture the User's 134 identification, account information for billing, telecommunication details such as type of communication device, telephone number, communication protocol, format, device type or model, and positioning capability. Other User 134 specific information managed by the System 130 includes, security information, preferences, and other details specific for individual users such as “buddy lists.” A “buddy list” is a user defined list of other Users with whom User defined location specific information is shared.

The location objects implement the data and behavior of geographical entities. Locations 136 are added to a Realm 132 databases based on Realm logic and a creation event. When a Realm 132 is initially created, there are no Locations 136. Locations 136 are initialized by the creator of the Realm 132 or through a creation event of the Users 134. Locations 136 include points of origin, areas of interest, service areas, locations size and the like. All locations contain Content 138. Table 1 illustrates one example of a Location 136 structure.

TABLE 1
Example Location Structure

| Item | Detail |
|---|---|
| Latitude | geo-location |
| Longitude | geo-location |
| Altitude | geo-location |
| Radius | Optional definition of how “big” this |
| | location is. Describes a circle from the |
| | origin points of lat, long. |
| Rectangle | Optional definition of how “big” this |
| | location is. Describes a rectangle from |
| | reference of the lat, long. |
| ServiceList | Reference to a list of Services. |
| OnEnter | Reference to an executable to run when a |
| | User enters this location. |
| OnIn | Reference to an executable that will run |
| | when the User stays within the location area |
| | for a specified period of time. |
| OnExit | Reference to an executable that will be run |
| | when the User exits from this location. |
| Rating | Accumulates the overall rating of this |
| | Location. A summary of all ratings. |

The size of a Location 136 is determined by the resolution capacity of the positioning technology and of this application. If the location determining equipment or LSP can only provide a resolution of, for example, 300 feet then the user's position will fall somewhere within that 300 foot area. If a user were then to request information within 200 feet, the inability of the LSP to resolve to 200 feet will result in a default to the highest resolution possible, i.e. 300 feet.

The size may be User selected, System 130 selected, or determined by the type of equipment used by the User 134. For example, a LSP servicing a given type of User 134 with a given type of PDE may return a default “size” that will include an origin and the approximated resolution e.g. an origin with a radius of uncertainty, which may, for example, be expressed as plus or minus some distance unit or in some other form. This resolution and therefore “size” will change if equipment is swapped out with higher or lower resolution technology or as upgrades to the System 130 occur. This size factor determines if a User 134 is in or out of a defined Location 136.

Locations 136 may have one or many Services 135 associated with them. The Services 135 provide utilities and behaviors that allow the Users 134 to interact with the Content 138 and applications associated therewith. Services 135 are primarily identified by their Context and topic. When Users 134 subscribe to the Service 135, the User's 134 reference is attached to the service. A reference to this user is placed within a service personalization database. The user is now part of that service “community”. Services 135 are organized by the Context in which they will be used. Table 4 illustrates some features of various service 135 items.

TABLE 4
Service Definition

| Item | Detail |
|---|---|
| Context | Scope, security, domain! |
| Topic | Subject matter or function |
| UserList | List of Users who are subscribed to this service |
| OnSubscribe | Database field that holds a path to an executable action to |
| | take when someone subscribes to this service. |
| | This path/executable may point to any special |
| | requirements or set up that the user is required to make. |
| OnUnsubscribe | Database field that holds a path to an executable action to |
| | take when someone is actively using this service. |
| OnActive | Database field that holds a path to an executable action to |
| | take when someone is actively using this service. |
| OnInactive | Database field that holds a path to an executable action to |
| | take when someone is actively using this service. |
| Special | Special information that is unique to this service. |

The behavior fields: OnSubscribe, OnUnSubscribe, OnActive, OnInactive fields are set to the appropriate behaviors, e.g., Executables, scripts or other programmatic actions callbacks of this new service. Each of these will perform some Service 135 specific function. OnSubscribe may validate billing and perform other subscription tasks. OnActive indicates to the Application that a User 134 is currently actively using the System.

Services 135 can draw on a preference interface that allows Services 135 to dynamically add preference pages to a User list of preferences. The user object would therefore include service management in its portfolio of capabilities. Users 134 may access their personalized setup which will include device type/model, preferences for messaging, selection of services, and other preferences which will assist them in modifying the behavior of their experience.

The Users 134 of the System 130 operate within specified Context provided by the System 130. Context in many ways is similar to “domain” as used with respect to the organization of the World Wide Web. In order to prevent confusion and more clearly denote functional differences, the term “Context” is applied to the location specific Content using the methods and systems disclosed herein. The Context of a Content 138 item describes how that Content is accessed and controlled. Context supports security and exclusivity.

Available Contexts are presented to Users 134 and are managed through the user account setup process. Table 2 illustrates example Contexts that may be setup by various types of Users 134 and the type of access privileges provided therewith.

TABLE 2
Example Contexts

| | Access | | |
|---|---|---|---|
| Context | Read | Write | Admin (R/W/D) |
| pub | User | User | |
| pub_moderated | User | User | pub.topic.admin |
| priv | User | User | User |
| priv_moderated | User.BuddyList | User.BuddyList | User |
| com | User | com.topic.admin | com.topic.admin |
| com_moderated | com.topic.BuddyList | com.topic.BuddyList | com.topic.admin |
| com_private | com.topic.BuddyList | | com.topic.admin |
| gov | User | User | gov.topic.admin |
| gov_moderated | gov.topic.BuddyList | gov.topic.BuddyList | gov.topic.admin |
| gov_private | gov.topic.BuddyList | | gov.topic.admin |
| edu | User | User | edu.topic.admin |
| edu_moderated | edu.topic.BuddyList | edu.topic.BuddyList | edu.topic.admin |
| edu_private | edu.topic.BuddyList | | edu.topic.admin |

This initial set of Context' are suitable to cover public, personal, commercial, government, and educational organizations. The use of “BuddyList” pertains to a list of users that may be set up by a Context administrator or by the User.

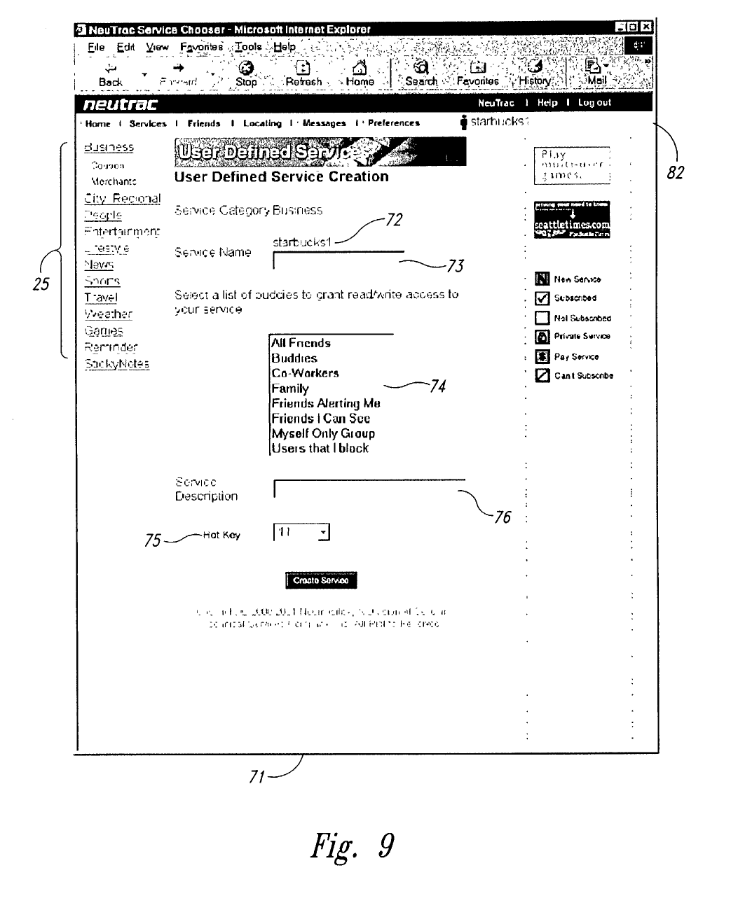

FIG. 9 illustrates a Private Service GUI 71 that allows users to establish a private moderated Context for other users that will have access to the location-specific content established by a particular user. Typically, a business user will use the Private Service GUI 71 to create a private moderated context to enable only certain types of other users, for example, employees, business associate, vendors and the like, to access information content concerning the business. The Private Service GUI includes a service category field 72 that defines the category for the service and a service name field 73 that defines a name for the particular business user. A group list field 74 is provided to allow users to set up specified lists of other users analogous to a buddy list. A hot key option 75 is provided to enable users to instantly access information content from the private service by use of a single entry key from the consumer device 20. A service description field 76 is also included to allow the business user to provide a short description of the groups and or finctions provided by the private service.

“Topic” refers to categories of information that are organized by related content or subject matter. When Context and Topic are combined, they may function like “channels” which limit the type of content transmitted to users 134. Topical Content may vary depending on the Context' with which they are accessed. For example, a Topic called “restaurant” within the Context of “com” (commercial) will access Content that has been generated by restaurant proprietors within a selected Location. A Context of “pub” under the same Topic and Location will access Content that has been generated by the public regarding restaurants in the Location. Realms 132 are preferably deployed with a “standard” set of Topics and additional Topics may be added. Table 3 illustrates example Topics and the Content provided therein as a function of Context.

TABLE 3
Example Topics

| Topics | Detail |
|---|---|
| Restaurants | Of course influenced by Context: |
| | Com.restaurants will provide restaurants with an avenue to |
| | promote and communicate with consumers in the location |
| | area. |
| | Pub.restaurants will provide the public with an avenue to |
| | communicate about a restaurant at the current location. |
| | Pub_moderated restaurants will provide the user with |
| | access to a moderated public point of view about the |
| | restaurant. The moderator of this could be a food critic |
| | for example. |
| | Com.private would provide the restaurant with an avenue to |
| | communicate with restaurant employees or suppliers, |
| | etc . . . |
| Traffic | Com.traffic will provide an avenue for commercial traffic |
| | information. This could allow various commercial services |
| | to supply information/apps about their services. |
| | Com_moderated traffic would provide a commercial |
| | vehicle for information and application use by users. |
| | Traffic value added services could operate in this |
| | “channel”. |
| | Pub.traffic would provide an avenue for public |
| | communication of traffic in that location. |
| | Gov.traffic would provide an avenue for government in |
| | content. |

Content 138 may be described through a system of Context/Topic pairs. Context broadly describes the accessibility and control of a Topic. Topic describes the content theme. For example Content within the topic Public.Restaurants describes Content which is not moderated, is open to the public, which deals with the subject of “restaurants” at a Location. Table 5 illustrates example content structures.

TABLE 5
Example Content Structures

| Item | Detail |
|---|---|
| Presentation | Defines the type of content by presentation. Content type |
| | could be text, SMS, URL, URL-HDML, URL- |
| | TinyHTML, URL-WML, Voice, Picture, etc . . . |
| Date | Date that content was created |
| Time | Time that content was created |
| Author | The User who submitted the content |
| OnAccess | Reference to external executable to run when this content |
| | is accessed by a User |
| OnDelete | Reference to an external executable to run when a User |
| | deletes this content. |
| OnEdit | Reference to an external executable to run when a User |
| | edits this content. |
| Rating | A User based rating score applied to this content. E.g., 1- |
| | 10 based on system rating system. |
| Data | Reference to actual content data. |

Content 138 is preferably ordered by both System 130 preferences and by User 134 preferences. Ordering of some topics may be by “nearest” or by “best” or other characteristic.

The Presentation 140 of Content 138 will vary widely depending on device. Robust presentation objects are used to implement this through the device interface. Presentation objects may also be constructed to support multiple Presentations 140 from a single Content source 138 based on user preferences or equipment. For example, the Presentation 140 of the same Content 138 could be text for one user 134, voice mail for a different user or an HTML page for a third user. In addition the User 134 may have multiple capacities for receiving Presentations 140 of Content 138 and may change the preferred type of Presentation 140 from time to time. A default type of presentation is optionally stored in a user preference file. One advantage of the separation of Presentation 140 from Content 138 is that this permits flexibility in the design of the System 130 to respond to changes in technologies and in device capability or performance.

The following Examples illustrate various features, services or other aspects of the invention that may be implemented in various embodiments using the systems and methods described herein.

### EXAMPLE I

### Traffic Information

A user accesses a presence server 30, enters his or her work address as a point of origin, selects a channel designated “com.traffic” from a PDA. The user receives a map displaying a plurality of highways and thoroughfares surrounding the point of origin and receives up to date reports on the traffic on the various routes provided by a real time traffic service. The user then activates a position determining GPS device configured with the PDA to obtain and transmit the users position. As the user travels down a selected route the GPS coordinates change and are transmitted to a plurality of receiver locations along the route, which in turn transmit updated traffic maps and reports at each location.

In this system the traffic application may be executed from either within the processing environment of the System 130 or externally from the traffic information provider's site. The Application may, for example, acquire a real time traffic feed from a government agency such as the Department of Transportation, or from a commercial provider. This information would be parsed and stored for the various locations along known traffic routes.

In an alternative procedure, the user proceeds down the route with a mobile phone configured with position determining equipment activated to transmit the consumer's position. The user had previously configured the mobile device to receive traffic route information. When the consumer's position is detected at a location along the route with updated traffic information, the consumer's cell phone is dialed by an automated computer system and a voice message is transmitted to the consumer regarding an accident has occurred near that location.

The user's preference for alerts and format thereof are set through account management through the system application. The System application places corresponding traffic alert content in the respective private.traffic Context for that user. Presentation of this Content is via the associated presentation object.

### EXAMPLE II

### Location Touring

Government agencies, and/or commercial enterprises create information content regarding various attractions and amenities available in a defined geographic area, such as a city. The content is attached to locations within the city that are stored on a database operated in the context of a commerical.tours service.

When a user accesses this service, for example, through a mobile communication device, the service executes an application script contained in the OnSubscribe field in the Service data table. An OnSubscribe handler then prompts the user to accept a charge for this service that will be placed on their mobile service carrier bill for the user. If the user accepts the charge the service is enabled for that user.

The user activates their mobile communication device e.g. a cell phone and proceeds with a physical tour of the geographic area. As the user navigates from location to location on the tour, the Content specific for different location on the tour is presented to the user's device as per the user's preferences, i.e., through a Voice tour, SMS messages or other format. The user may opt to manually send location information for each site that is reached by entering an address or street intersection, may have the user's location automatically sent to the service from a LSP or MPC as the user's position is tracked, or may obtain GPS coordinates for each location and then transmit that information to the service when desired. The user may request a route for a preselected tour, or make the tour extemporaneously. Optionally, the user may select certain channels within the tour, for example, a historical channel, that sends historical information regarding various locations in the vicinity of the users position.

### EXAMPLE III

### Electronic Coupons

Retail locations create an electronic coupon message as Content for their location under a service such as retail.coupons within the System. A user that accesses this service and that comes to a location in the vicinity of the business will be sent the coupon message automatically and in the users preferred format for their communication device.

### EXAMPLE IV

### Auto Toll

A commuter user routinely passes through a toll point, ferry, train or other transport service that requires a toll for use. The transport service establishes locations on the System specific for each location where a toll is required. The service may be organized under a category or channel denominated, for example, as Washington.tolls. The user activates the Washington.tolls service on a mobile positioning and communication device and then drives by a particular toll location. When the user enters the toll location, an indication of the user's presence is received from the device at the toll location, and an OnEnter event is executed that transmits the driver's license plate, identifying information and an electronic payment script that executes an electronic debit from an account owned by the user, to the toll service.

### EXAMPLE V

### Family Archive

A father and his sons are out mountain biking and come across an outstanding view where they eat lunch and talk about life. To mark this occasion and moment the father pulls out his cell phone and he and his sons enter a voice message that is stored with an indication of the particular geographic location on a private class and sports channel service provided by the System 130. The System 130 automatically timestamps the messages and attaches it to the location with a default radius for area of interest applied to the location. Alternatively, the father stores a digital picture or some other record of the location on other media. There is now a record of this family trip attached to that particular physical location. On this trip there may have been many others associated records made at different locations along the way.

The location specific records are accessed in the comfort of the family home by contacting the System 130 via the World Wide Web when the family returns. The family can also use data-mining and presentation tool applications to display the entire trip and use other applications to add further information regarding the experience. Two summers later, the father and sons take the same trip again. This time, along the way, they access the system 130 in a sense mode, choosing the same Context and channel as the records were stored. As the family enters these “hot” locations they are presented with the messages that were left several years ago.

In this scenario, the father or sons could also have left public messages for others to discover, and could have accessed other's experiences with these locations by having the location information stored in a public or moderated public Context.

### EXAMPLE IV

### Restaurant Experience

A restaurant owner has a Web site on the World Wide Web. The owner places this Web reference (URL) along with location data into the System 130. When people in the area are attempting to sense any restaurant or the owner's restaurant in particular using a communication device, the presence server detects the presence of the device and the owner's Web page is transmitted to the potential customer in the consumer's preferred format. The chef may pick up a cellular phone that morning and enter today's specials via voice, text, or SMS message to the system. Potential patrons coming into that location will have an option to view the home page of the restaurant through a WAP, listen to today's specials through voice mail, or receive an SMS message on their device.

While in front of the restaurant the customer may access a public/Restaurant/Rating for that location. That public Context provides ratings tabulated from all previous entries members of the public (unmoderated), or from particular members of the public (moderated) which may, for example, be a food critic from the local newspaper. Concerned about how late it is and the safety of the area, the prospective customer could also obtain a public safety rating, or other information attached to that location 136 on the system 130.

While in the restaurant, the customer (who has an interest in architecture) notes the age and beauty of the restaurant. The customer then accesses a Public/History channel for that location and is presented with anecdotes or other information contributed by others who have visited that location having a similar interest. For information that is more regulated or packaged, the customer may access a moderated version of this channel for a more “textbook” view on the history of this location.

The patron may then wonder if they know who has eaten there before and if any messages were left. The patron then applies his “buddy list” filter on the public forums associated with this location and obtains several interesting and comical messages or stories left by the patron's friends and family who have visited this location.

### EXAMPLE VII

### Theatres

A user arrives in an unfamiliar city on a business trip and wants to go to a movie or concert, or the user remains at home but does not know what movies or concerts are playing in the city. The user accesses the System 130, enters his current point of origin, selects a channel designated “theaters” and is automatically sent a list of all concerts and movie theatres that fall within the user's default area of interest or radius. Alternatively, if the user's device is not equipped with a graphical display, a list can be obtained by voice or text messaging. The list is sorted by proximity to the user's point of origin starting with the nearest venue. The user may also access comments left by the public or individuals on the user's buddy list who've seen the movie. The user may also obtain location specific information about the theatre, the sound system, the popcorn, the seats and the like. The same concept can be applied to finding concerts. The user may also use more detailed searching and filtering to find, for example, the closest theatre with THX or Dolby Digital sound that's showing a specific movie at a specific time.

### EXAMPLE VIII

### Finding Persons with Mutual Interests

Various users define or otherwise categorize subject matter of personal interest (or profile) and list their name and contact information in association with a location 136 on the System 130. When one user sends an indication of a particular location, and has a preference filter or channel set to “personal interest”, the user receives a message that lists the name and contact information for the other users associated with that location that share that interest. The user may therefore meet unknown people in proximity to their location whose interests or profile matches the profile of the user.

In certain embodiments, location based personal interest channels may operate like a real-time personal ad. Users can arrange, for example, to meet fellow travelers with similar interests in a foreign country. In another example, users can arrange to companion with other mountain-bikers in a given area by posting a message saying for example, “female mountain biker seeks same for trip to Tiger Mountain at 11:00 this morning to share costs, casual rider who takes it easy, so no gung-ho types please.” Similarly, a message can be posted that will reach bikers in a specific location at a specific time if the user specifies the same. In an unrelated example, a user could advertise a ticket for sale at a location outside a crowded event and be contacted by people at the event who set up their profile to indicate they are interested in tickets, and/or are also located near the event.

Conventional dating through personal ads based on location is also possible. In a preferred practice, a user's actual address or personal contact information would not be disclosed automatically, but would merely provide sufficient information for follow-up messaging. Safeguards and so called “handshaking procedures” would be used to control who can contact who. For example, if users did not want to give out cell phone numbers, E-mail address and the like, a location based message center could be established to exchange initial correspondence.

### EXAMPLE IX

### Finding Nearest Participating Physicians in a Health Plan

A user has a health plan that lists 10 participating physicians within the user's area. Having no idea which one to see, the user accesses location information using a category filter called “health care providers” under a context designated as public or public moderated to obtain a list of doctors within that location and public reviews concerning the service of the physician or their institution.

### EXAMPLE X

### Graffiti

Some users desire to associate artistic expressions with particular locations in virtual form rather than with spray paint. Such users could create such expressions in electronic form and associate them with a location under a category topic designated as “graffiti” on the system 130. Other users interested in viewing the same can obtain graffiti for particular locations using the methods and systems disclosed herein.

### EXAMPLE XI

### Employment

Many jobs are location specific, or employers or employees may offer or desire jobs with location specific restraints. Employers could post location specific job descriptions, information about themselves or the job, and contact information for interested applicants. Conversely, job seekers within a given location could post their own resumes associated with their location. The systems and methods described herein are readily adaptable for locations specific job searching.

### EXAMPLE XII

### Simple Location Ratings

Posting and access of public or private reviews of particular locations has been described herein before. The system 130 and methods are also readily adaptable to attaching simple types of public ratings to particular locations. A service could be established that merely holds content that consists of a number between 1-10, “bad”, “good”, “great,” or number of stars. People can associate their personal rating with a location and the service would merely average the ratings.

Although various illustrative and specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. The scope of the invention includes any other applications in which the above structures and fabrication methods are used. Accordingly, the scope of the invention should only be determined with reference to the appended claims, along with the full scope of equivalents to which such claims are entitled.

1. A method for providing a virtual I journal, comprising:
receiving a journal entry in an electronic medium from a first user, the journal entry including a definition of a geographic point of origin and information content associated with the geographic point of origin;
receiving an indication from a consumer device that includes a location defined by a second user; and
presenting the journal entry in electronic medium to the consumer device if the defined location received from the second user overlaps with the geographic point of origin defined by the first user.

2. The method of claim 1 wherein the first user is the same as the second user.

3. The method of claim 1 further including receiving an identification of the second user from the first user and wherein presenting the journal entry occurs only if the second user is a user identified by the first user.

4. The method of claim 3 wherein the identification of the second user comprises a buddy list of a plurality of second users.

5. The method of claim 1 further including defining a context criteria of access for the second user, and wherein presenting the journal entry only occurs if the second user is a user within the context criteria.

6. The method of claim 1 wherein the definition of the geographic point of origin is selected from the group consisting of a place name, a geographic address and geo positioning coordinates.

7. The method of claim 1 wherein the geographic point of origin includes an area of interest.

8. The method of claim 7 wherein the area of interest is at least one of, defined by the first user, assigned by a service provider, selected by the first user from a list, defined as a geographical boundary, and defined by a geometric form encompassing a defined distance a point origin for the geographic location received from the first user.

9. The method of claim 1 wherein the indication of the location received from the consumer devices includes an area of interest and wherein the journal entry is presented to the consumer device only if the area of interest overlaps with the definition of geographic point of origin.

10. The method of claim 9 wherein the area of interest is at least one of, defined by the second user, assigned by a service provider, selected by the second user from a list, defined as a geographical boundary, and defined by a geometric form encompassing a defined distance from a point origin of the second user.

11. The method of claim 1, wherein the information content associated with the geographic point of origin includes an indication of a first category of interest, and wherein the journal entry is presented to the consumer device only if the second user indicates a second category of interest that overlaps with the first category of interest.

12. The method of claim 11 wherein at least one of the first category of interest and the second category of interest determined from a list of keywords contained within the information content.

13. The method of claim 1 wherein receiving the indication of location from the second user includes receiving geographic positioning coordinates from the consumer device.

14. The method of claim 13 wherein the geographic positioning coordinates are automatically changed as the location of the consumer device changes, and wherein the presentation of the journal entry changes in response to the changed location of the consumer device.

15. The method of claim 1 wherein presenting the journal entry includes selecting at least one of a protocol and a format that is compatible with the consumer device and wherein the journal entry is presented using at least one of the compatible protocol and format.

16. The method of claim 15 wherein the at least one of the compatible protocol and format is selected from a group consisting of HTML, XHTML, Web format, Wireless Application Protocol, Wireless Markup Language (WML), Voice Extensible Markup Language (VoiceXML), Short Message Service (SMS), and E-mail.

17. The method of claim 1 wherein the journal entry includes a Web page and the act of presenting presents the Web page to the second user if the consumer device has the capability to view the Web page.

18. The method of claim 1 wherein the journal entry is presented as an E-mail message to the second user if the consumer device has the capability to receive E-mail.

19. The method of claim 1 wherein the journal entry includes an audio file and the act of presenting presents an audio message to the consumer device if the consumer device has the capability to receive an audio file.

20. The method of claim 1, wherein the act of presenting to the consumer device is selectively enabled or disabled by the second user.

21. A system for sharing journal entries between users, comprising:
a presence server that stores a journal entry concerning a geographic location of interest, the journal entry including a defined point of origin for the geographic location of interest and information content concerning the geographic location of received from a first user;
a communication port operably configured with the presence server to receive an indication of a second user's location from a consumer device and to present the journal entry to the consumer device if the indication of the second user's location overlaps with the geographic location of interest; and.
a device interface operably configured with the presence server to format the journal entry to be compatible with the consumer device in at least one of a protocol and format recognized by the consumer device.

22. The system of claim 21, further configured to communicate with a location service provider to receive the indication of the second user's location and to receive an indication of the at least one of the protocol and format recognized by the consumer device from the location service provider.
